(19) United States
(12) Patent Application Publication
(10) Pub. No.: US 2009/0095601 A1
(43) Pub. Date: Apr. 16, 2009

(54) Circulation Type Conveying Device

(75) Inventors: Haruki Ishino, Ishikawa (JP); Shigeki Ishino, Ishikawa (JP); Hatsuyoshi Oda, Ishikawa (JP); Shintaro Sasahara, Ishikawa (JP)

Correspondence Address: CHAPMAN AND CUTLER, 111 WEST MONROE STREET, CHICAGO, IL, 60603, US

(73) Assignee: ISHINO SEISAKUSYO CO., LTD, ISHIKAWA (JP)

(21) Appl. No.: 11/883,407

(22) PCT Filed: Nov. 9, 2005
(86) PCT No.: PCT/JP2005/020530

§ 371 Date: Oct. 30, 2008

(30) Foreign Application Priority Data
Feb. 1, 2005 (JP) 2005-025619

(51) Int. Cl. A47G 23/08; B65G 21/20

(52) U.S. Cl. 198/837

(57) ABSTRACT

An object of the present invention is to provide a circulation type conveying device easily transportable, easily assembled in installation, and useful for a user by projecting tables. The circulation type conveying device (1) comprises a base (2), a carrying unit (3) placed on the upper part of the base (2) and cyclically moving carried articles, and the tables (4a) and (4b), wherein the base (2) is opened at least on one part of its upper side, the tables (4a) and (4b) are movable between a position where the opening of the base (2) is closed and a position where they are projected outwardly from the base (2) to open the opening, the carrying unit (3) is able to be placed on the opening portion of the base (2), and the tables (4a) and (4b) and the carrying unit (3) are immovably assembled into the base (2) when the carrying unit (3) is placed on the base (2).

### TECHNICAL FIELD

The present invention relates to a circulation type conveying device consisting of a base, a carrying unit which is placed on the upper part of the base and moves cyclically carried articles, and tables.

### BACKGROUND OF THE INVENTION

Conventionally, circulation type conveying devices with a carrying unit on the upper part of a base and with tables are used as in sushi restaurants called “sushi-go-round restaurant” and food and drink parlors. Such devices move cyclically foods and drinks and so customers can pick their favorite foods and drinks up without their moving. Also they can have some foods and drinks on the tables protruding from the base. For the restaurants, since their employees don't need to serve every customer, the manpower cost and so are able to be decreased as much as possible. (See Patent Document 1)

Nevertheless, regardless how small this circulation type conveying device might be, it is an all-in-one base and tables and carrying unit, and so it takes a lot of time and effort to transport and install it inside a restaurant. In view of such circumstances, a circulation type conveying device with a transporting route is provided to be able to be divided into a linear transporting route unit and a curve transporting route unit. It is assembled from the units in the actual field. (See Patent Document 2)

### Patent Document 1:

### Japanese Patent Application Laid-Open No. 2002-65443 (Paragraph 0012, 0013, FIG. 1)

### Patent Document 2:

### Japanese Patent Application Laid-Open No. 2002-432 (Paragraph 0007˜0011, FIG. 1, 2)

### DISCLOSURE OF THE INVENTION

### Problems to be Solved by the Invention

As referred in the above patent document 2, such circulation type conveying device is useful to be transported in several units but is difficult to be assembled for matching of a linear transporting route and a curve transporting route.

The present invention is aiming to solve these problems and provide a circulation type conveying device easily transportable, easily assembled in installation, and useful for a user by projecting tables.

### Means for Solving the Problems

In order to solve the problems as described above, according to a first aspect of the present invention, a circulation type conveying device comprises a base, a carrying unit placed on the upper part of the base and cyclically moving carried articles, and the tables, wherein the base is opened at least on one part of its upper side, the tables are movable between a position where the opening of the base is closed and a position where they are projected outwardly from the base to open the opening, the carrying unit is able to be placed on the opening portion of the base, and the tables and the carrying unit are immovably assembled into the base when the carrying unit is placed on the base.

According to such aspect, when this circulation type conveying device is transported, a base with its opening closed by retracting tables and a carrying unit are separately transported. Then, when this circulation type conveying device is assembled, the tables will be projected outwardly releasing the upper side opening of the base where the carrying unit is being imposed. In moving the base, the transportation capacity of the base can be compacted and so it is convenient to transport the base. Moreover, when this carrying unit is being set on the base, the outwardly projected tables which open the upper opening are immovable and are able to be used as a counter table for the carried articles placed on them.

According to a second aspect of the present invention, the circulation type conveying device according to the first aspect is characterized in that the movement of the tables is restricted by the rail put on the base, and the carrying unit's movement toward the tables is restricted by the tables which are in the position where the tables open the opening of the base and their movement is restricted.

In the above aspect, the table would be moving horizontally with consistency according to the rail and the movement of the carrying unit towards the table would be restricted by the tables under movement restriction. Therefore no other means for restricting its movement is necessary.

According to a third aspect of the present invention, the circulation type conveying device according to the first or second aspect is characterized in that the storage box is mounted on the base and removed from it, the carrying unit's movement toward the storage box is restricted by the storage box which is set up within the base.

In the above aspect, the carried articles being conveyed by the carrying unit can be stored within the storage box, and when the storage box is removed from the base, the tables can close the upper side opening without no difficulty. Moreover, when the storage box is mounted on the base, the movement of the carrying unit towards this storage box will be deterred by the storage box itself. Accordingly, no other means for restricting the carrying unit's movement is necessary.

According to a fourth aspect of the present invention, the circulation type conveying device according to the first to third aspects is characterized in that the tables are consisted of a pair of tables which can open and close the opening from both sides.

In the above aspect, the pair of tables can open and close the opening from both sides and so the moving distance of the tables for obtaining a predetermined area of the opening is shorter than the moving distance of only one table.

According to a fifth aspect of the present invention, the circulation type conveying device according to the fourth aspect is characterized in that the carrying unit is fit in between the pair of tables which open the opening.

In the above aspect, when the carrying unit is fit in between the pair of tables, the carrying unit is held securely without creakiness. Especially, in the case the movement of the tables is restricted by the rail, if the carrying unit is fit in between the tables, the movement of the carrying unit would be deterred without another means for restricting its movement.

According to a sixth aspect of the present invention, the circulation type conveying device according to the first to fifth aspects is characterized in that the carrying unit has a connecting means by which the carrying unit is automatically connected with a driving means set in the base for driving the carrying unit when the carrying unit is placed on the base.

In the above aspect, when the carrying unit is placed on the base, the connecting means of the carrying unit is automatically connected with a driving means and so it takes short time to assemble the circulation type conveying device.

According to a seventh aspect of the present invention, the circulation type conveying device according to the sixth aspect is characterized in that the carrying unit has a locating pole in its under surface to decide its setting position on the base, and the locating pole is fitted into a locating hole set within the base before the connecting means is connected with the driving means in the carrying unit being placed on the base.

In the above aspect, after the carrying unit's setting position on the base is decided, the connecting means is connected with the driving means. Then the connection is able to be ensured, and the damage to the connection part from location gap etc. is prevented.

According to an eighth aspect of the present invention, the circulation type conveying device according to the first to seventh aspect is characterized in that several of the bases set with the carrying unit are connected continuously.

In the above aspect, the length of the carrying unit can freely be decided by selecting the connection number of the bases.

### BRIEF DESCRIPTION OF THE DRAWINGS

FIG. 1 is a perspective view illustrating a circulation type conveying device as the embodiment of the present invention;

FIG. 2 is an exploded perspective view illustrating the circulation type conveying device in FIG. 1;

FIG. 3 is an enlarged view illustrating a fitting condition with a carrying unit;

FIGS. 4 (a) and (b) are enlarged cross-section views illustrating the structure of a driving mechanism and the connecting situation of it;

FIG. 5 (a) is a flat surface diagram of the component of the Driving Mechanism; FIG. 5 (b) is the cross-sectional diagram of FIG. 5 (a) line A-A;

FIG. 6 is a disassembled diagrammatical perspective view of the circulating type conveying device in its converted state by the application of the carrying unit to it; and

FIG. 7 is a diagrammatical perspective view of the condition in which several of the circulating type conveying devices are connected laterally.

### REFERENCE NUMERALS

1 Circulating Type Conveying Device
2 Base
3 Carrying Unit
4a, 4 b Table
5 Slide Rail
6 Ingredient Case (Storage Box)
7 Spacer Plate
8 Driving Motor (Driving Means)
9 Convex fitting part
13 Driving Axis
14 Driving Shaft (Connecting Means)
15 Sliding Pin (Connecting Means)
16 Linkage Panel (Connecting Means)
17 Insertion Hole (Connecting Means)
18 Inlet Hole (Connecting Means)
18a Tapered Face (Connecting Means)
19 Slotted Slide Hole (Connecting Means)
20 Connecting Tube (Connecting Means)
21 Joint Pin (Connecting Means)
23 Positioning Shaft (Locating Pole)
24 Locating Hole

### BEST MODES FOR CARRYING OUT THE INVENTION

Embodiments of the present invention are described as below

### Embodiments

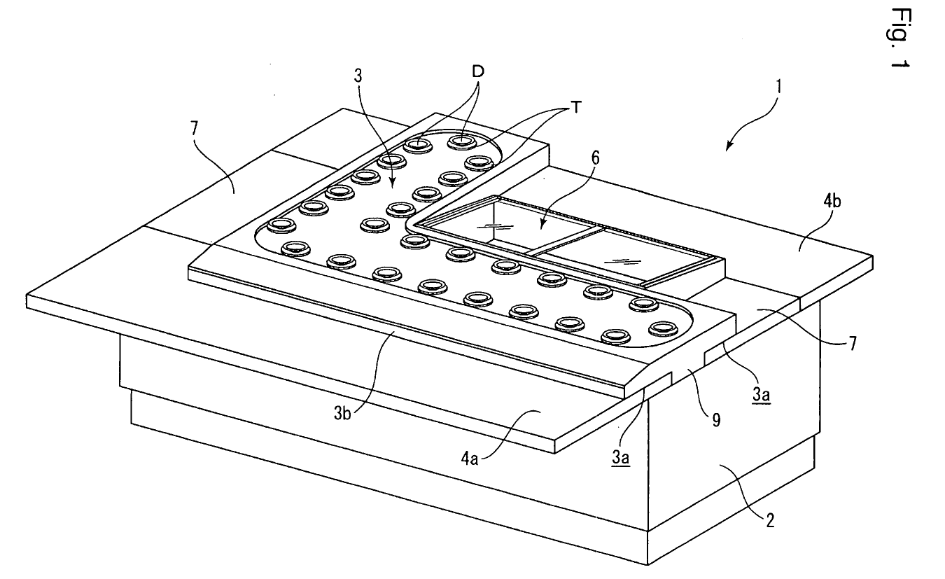

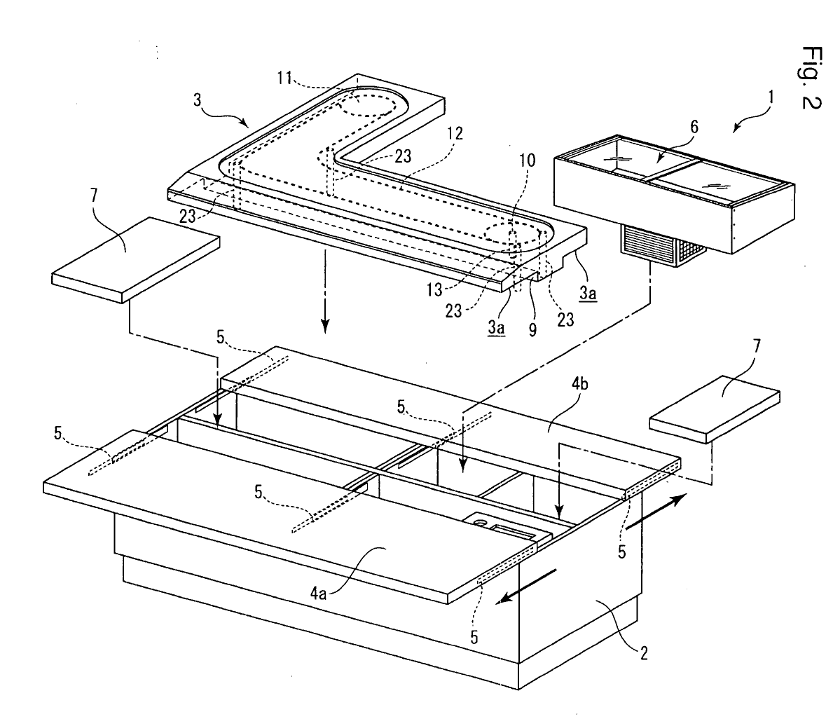

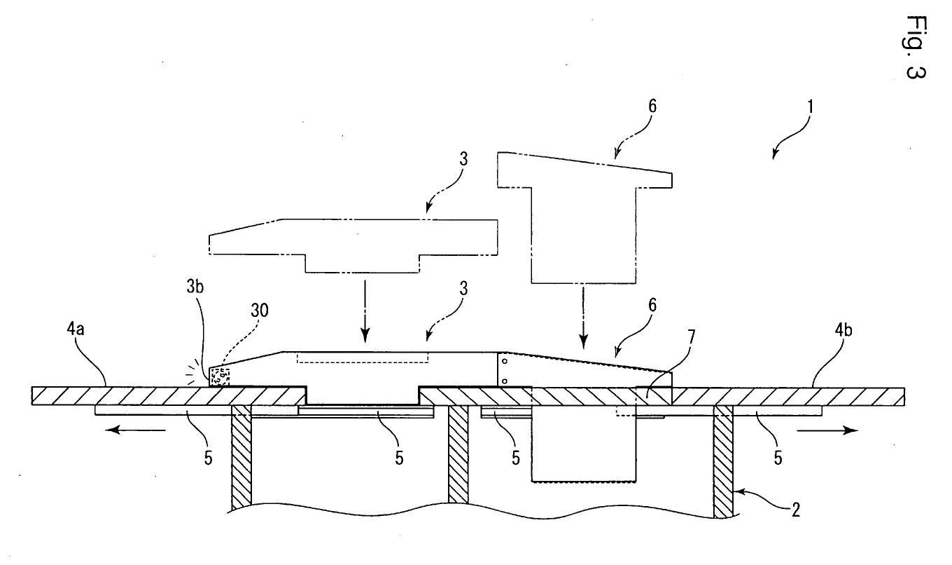

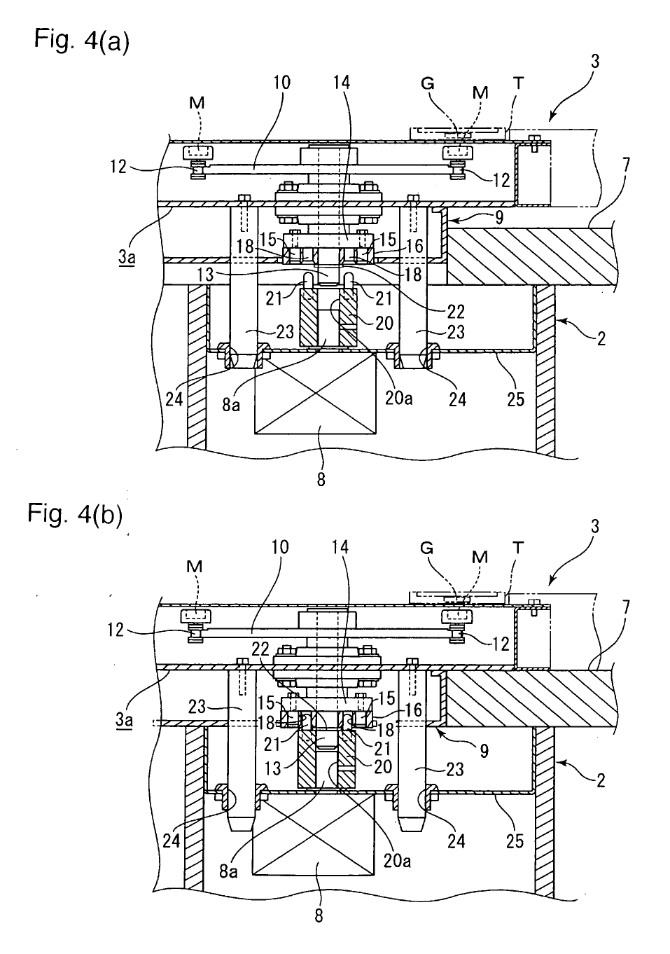

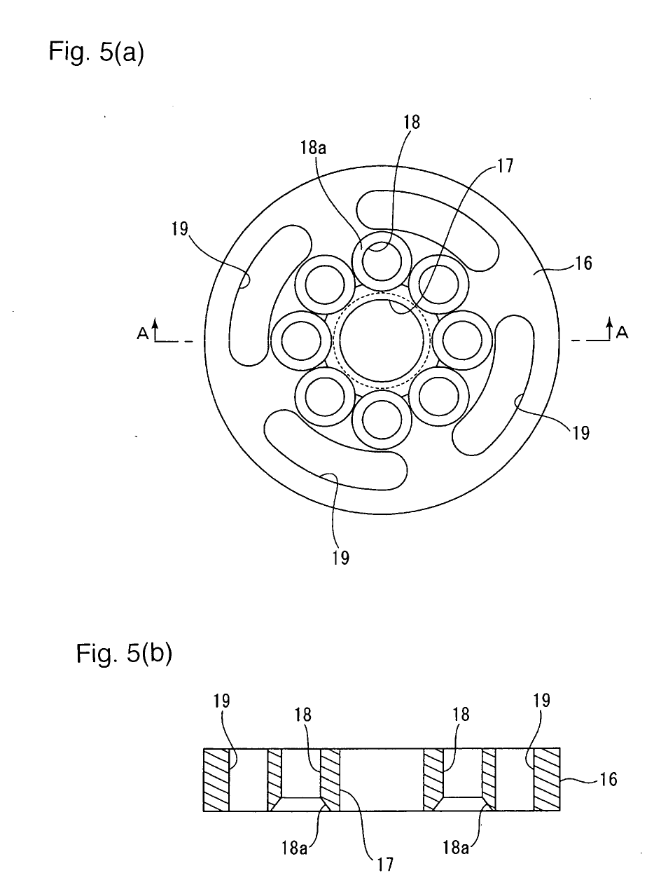

The embodiments of the present invention are described on the basis of the drawings. First, FIG. 1 is a perspective view illustrating a circulation type conveying device as the embodiment of the present invention. FIG. 2 is an exploded perspective view illustrating the circulation type conveying device in FIG. 1. FIG. 3 is an enlarged view illustrating a fitting condition with a carrying unit. FIGS. 4 (a) and 4 (b) are enlarged cross-section views illustrating the structure of a driving mechanism and the connecting situation of it. And FIG. 5 (a) is a flat surface diagram of the component of the driving mechanism; FIG. 5 (b) is the cross-sectional diagram in line A-A of FIG. 5 (a).

As FIG. 1 illustrates, the embodiment of the circulation type conveying device of this invention is mainly composed of a box-shaped base 2 having the opening on its upper side, a carrying unit 3 which is placed on top of the base 2 and circulates the transported items such as the sushi plates D etc, and a two plate-like tables 4a and 4b that are divided anteroposteriorly. Code no. 6 is the ingredient case as a storage box for storing the “Neta” (sushi ingredient) and other food ingredients. Code no. 7 is the spacer plate which functions as the closure of the upper part opening

The base 2 is formed into box-shape to open its upper opening part. On the top of the base, several of slide rails 5 are placed to sustain the tables 4a and 4b in a slide-action. In the designated interior area of the base, the driving motor 8 (see FIG. 4) is placed as a driving means to drive the chain 12 (see FIG. 2, FIG. 4) within the carrying unit 3.

As shown in FIG. 2, table 4a and 4b each is sustained by the slide rail set on the base 2 to be able to slide between the opening position, where the tables are outwardly from the side plate of the base 2 to open the upper side opening, and the closing position, where the tables close the upper side opening. When the tables are in the opening position, the outer end sides of the tables are widely projected from the side plate of the base 2 for the table to be used as a counter on which the sushi plates D etc. are put. And when the tables are in the closing position, the outer end sides of each would stand in almost same position to the side plates of base 2. Both of the tables 4a, 4b would be compactly housed in the space above the upper side opening. Moreover, when both of tables 4a, 4b are moved in the opening position, a restricting means, not shown in the drawings, of slide rail 5 prevents the tables from moving to the outside direction.

In a planar view, the carrying unit 3 is shaped in an L shape, and on top of the carrying unit there is a flattened transporting line to convey sushi plates D while circulating. And an elongated convex fitting part 9 is protruded from the under surface 3a of the carrying unit and along the longitudinal direction of the conveyor unit 3. And when the under surface 3a of the carrying unit 3 is laid on front and rear tables 4a, 4b, this convex fitting part 9 is fitted between the opposed end faces of the tables 4a and 4b in their mutually opening.

In the interior part of the carrying unit, there are an actuation sprocket wheel 10, a driven sprocket wheel 11 and an endless chain 12 which winds around them, as a circulating mechanism. Especially as shown in FIG. 4, in this chain 12 several magnets M are arranged in designed interval along the longitudinal direction to attract and convey the tray T of the sushi plates D on the surface of conveying pass. And also each tray T has magnetic substance G. Therefore, when the chain 12 is rotating, the magnetism of magnets M in chain 12 attracts and conveys the tray T while circulating.

The front end side 3b of the carrying unit 3 is made from transparent synthetic-resin panel, while in the interior a fluorescent lamp 30 is built for illuminating the top face of table 4a.

An action of such circulation type conveying device is explained as follows. First, the base 2, the carrying unit 3, the Neta case 6, and the Spacer Plate 7 of the circulation type conveying device 1 in this embodiment are carried separately to the site. And then when the tables 4a, 4b of base 2 are set in said closing position, the capacity of the base 2 is smaller and its transportation is easier.

And after the base 2 is installed in the desired site, this circulation type conveying device is assembled. For details, when the tables 4a, 4b are withdrawn outwardly, as shown in FIG. 3, the upper side opening of the base 2 is in the opening position.

Next, the carrying unit 3 is set after the spacer plate 7 and the Neta case 6 are placed in their designated area of the upper side opening between the opposite end faces of tables 4a and 4b. That is, when the under surfaces 3a of the carrying unit 3, which are in front and in the rear of the convex fitting part 9, are laid on table 4a and 4b, the convex fitting part 9 of the carrying unit 3 is placed in the space formed between the opposite end faces of the front and rear tables 4a and 4b opened mutually. In this way when the carrying unit 3 is set on the base 2, the tables 4a and 4b will be fixed in the opening position where these tables are protruded outwardly to be used as a counter for putting transported items such as the sushi plates D etc.

Since the movement of tables 4a and 4b is restricted by slide rail 5 set in base 2, and the movement of the carrying unit 3 towards said tables, in their opening position, is also restricted, the carrying unit 3 is set easily only by fitting it between table 4a and 4b from the upper side.

Moreover, since the tables 4a and 4b are made of a pair of tables to be able to open and close the upper part opening of the base 2 from both sides, their movement for getting a designated opening is shorter than one made of one table.

Furthermore, the carrying unit 3 is attached firmly by setting the convex fitting part 9 between a pair of tables 4a and 4b in their opening position. And since the movement range of tables 4a and 4b are also restricted by sliding rail 5, only by fitting this carrying unit 3 between tables 4a and 4b, its movement is limited without adding another movement restricting means.

Also, the horizontal movement of table 4a and 4b is stabilized by the slide rail 5, and since the movement of the carrying unit 3 towards table 4a and 4b is restricted by the tables which movement is restricted by the slide rail Stables, another movement restricting means would not be necessary.

Furthermore, according to this embodiment, the opening of the upper part opening of base 2 by the releasing of table 4a and 4b is bigger than the convex fitting part 9, but if neta case 6 or spacer plate 7 will be set in the space of said opening, the movement of the carrying unit 3 towards the neta case 6 or the spacer plate 7 is restricted by the neta case 6 or the spacer plate 7 and another movement restricting means would not be necessary. Moreover, since these neta case 6 and spacer plate 7 are attached and removed freely in the upper side opening of base 2, they are transported independently from the base 2 and their position between table 4a and 4b is freely decided.

Moreover, if neta case 6 will be used as part of such spacer, the items conveyed by the carrying unit 3 can be stored within the neta case 6. When this neta case 6 is removed out of base 2, the opening between tables 4a and 4b can be conveniently closed.

Next, FIG. 4 and FIG. 5 shows the details of the connecting structure in which a driving axis 13 (refer to FIG. 2) extended downwards from actuation sprocket wheel 10 within the carrying unit 3 is connected automatically to driving motor 8 as a driving means arranged at the side of base 2, when the carrying unit 3 is attached to the base 2.

As shown in FIG. 4, a driving axis 13 extended downwards from actuation sprocket wheel 10 is protruded from an underplate as under surfaces 3a of the carrying unit 3 and it is rotatable to the underplate. A disc-like driving shaft 14 is fitted in the under part of the driving axis 13. And four sliding pins 15 (in the Figure only 2 are shown) arranged at intervals of 90 degrees in a concentric circle are protruding from the underside of the driving shaft 14.

As shown particularly in FIG. 5, under this driving shaft 14 there is a disc-like linkage panel 16 which has same diameter as the driving shaft 14 and can relatively rotate freely around the driving axis 13. In details, this linkage panel 16 has a insertion hole 17 for putting the driving axis 13 in its center, and eight inlet holes 18, where joint pins 21 mentioned later are inserted, in the surroundings of the insertion hole 17 at intervals of 45 degrees in a concentric circle.

On the underside of the inlet holes 18, tapered face 18a for guiding the insertion of joint pin 21 is formed. On the undersurface of the linkage panel 16, the biggest circumference part of each tapered face 18a approaches each other. Therefore, when the joint pin 21, mentioned later, is inserted into the inlet hole 18, even if the joint pin 21 stands in between two adjacent inlet holes 18, the tapered face 18a would function as a guide so that the joint pin 21 will be inserted in either of these inlet holes 18.

Moreover, on the outer side of these inlet holes 18, four slotted slide holes 19 are formed at regular intervals in a concentric circle, in which the sliding pin 15 protruded from the driving shaft 14 is inserted. The length of these slotted slide holes 19 is approximately twice as long as an outer diameter of the inlet hole 18. The rotation of the linkage panel 16 around the axis is permitted only for this length.

Such linkage panel 16 is prevented to deviate to the axial by the rock ring 22 set on the underside of it, in the state that the sliding pin 15 is inserted into the slotted slide hole 19. The linkage panel 16 is set to rotate around the driving axis.

On one hand, a driving motor 8 is fixed in housing 25 which is formed in the designated area of base 2, and the connecting tube 20 are connected with the driving axis 8a of this driving motor 8 to prevent the rotating of the circumference of the axis. This connecting tube 20 has insertion passage 20a to insert the driving axis 8a and the driving axis 13 in the center of it. And it has four joint pins 21 (in the Figure only 2 are shown) inserted into the inlet holes 18 on its upper side at intervals of 45 degrees in a concentric circle. Moreover, the tip of the joint pin 21 has been chamfered in a hemispherical shape to make itself smoothly inserted into the inlet hole 18.

Moreover, the housing 25, in which the driving motor 8 is fixed, has locating holes 24 into which several positioning shafts 23 (as shown in FIG. 2) (four shafts in this embodiment) extended downwards from the carrying unit 3 are inserted to locate the driving axis 8a and the driving axis 13 in their connecting.

That is to say, the driving shafts 14, the linkage panel 16, the connecting tube 20 and parts formed in these components (sliding pin 15, inlet hole 18, slotted slide hole 19 and joint pin 21) compose the connecting means for attaching the driving axis 8a and the driving axis 13.

In addition, since two of four positioning shafts 23 are set near the driving axis 13, it is possible to restrict surely displacement in the neighborhood of mutual connection between the driving axis 8a and the driving axis 13. And as mentioned later, the positioning shaft 23 is being fitted for the locating hole 24 before the driving axis 13 is being connected with the driving axis 8a, and so the position of the carrying unit 3 towards base 2 is decided. Further, it is possible not only to attach the driving axis 8a and the driving axis 13 securely, but also to prevent any damages of the connecting portion due to displacement.

Next, an action of such connecting mechanism in connecting is explained as follows. First, when the carrying unit 3 is put on tables 4a and 4b, and as already described, the fitting of the convex fitting part 9 is carried out between the opposite end faces of tables 4a and 4b, the carrying unit 3 must be put down as shown in FIG. 4(a) to insert the positioning shafts 23 within the locating hole 24. Then by inserting the tip of each positioning shaft 23 in the locating control hole 24, the direction and position of carrying unit 3 would be decided, and the head of driving axis 13 of carrying unit 3 would be guided in the insertion passage 20a of the connecting tube 20.

Moreover, by putting down the carrying unit 3, each head of the joint pins 21 would be inserted in inlet holes 18. If the central axis of the joint pin 21 and the central axis of the inlet hole 18 even are shifted to the circumference direction, since the tip of the joint pin 21 is formed in a hemispherical shape, and the inlet holes 18 have tapered faces 18a, and the circumference part of tapered face 18a of each inlet hole 18 approaches each other, accordingly, when the tip of the joint pin 21 will be contacted to the undersurface of the linkage panel 16, the joint pin 21 and the tapered face 18a slide mutually and the linkage panel 16 is rotated in either direction around the driving axis 13 and so the central axis of the joint pin 21 corresponds with the central axis of the inlet hole 18.

And when placing the underside 3a of carrying unit 3 on the top face of tables 4a and 4b, each of joint pins 21 would be perfectly inserted within the inlet holes 18 and the driving axis 13 on the side of carrying unit 3 and the driving axis 8a on the side of base 2 would be connected. Specifically, when the joint pins 21 are inserted in the inlet holes 18 and the driving axis 8a would rotate, and when this rotation is transmitted to the linkage panel 16, the rotation of the linkage panel 16 around the driving axis 13 is restricted by the sliding pin 15 inserted within the slotted slide hole 19, and the turning force is transmitted to the driving axis 13, so the driving axis 13 rotates and the chain 12 circulates.

In this way, if, while the driving axis 13 on the side of carrying unit 3 and the driving axis 8a on the side of base 2 are connected, any displacement between the joint pin 21 and the inlet hole 18 would occur, due to the rotation of the linkage panel 16 such displacement is permissible, and the driving axis 13 on the side of carrying unit 3 and the driving axis 8a on the side of base 2 can be connected without their rotation. Accordingly, there is no additional load applied to any components to connect the driving axis 13 and the driving axis 8a.

Moreover, when the carrying unit 3 is set on the base 2, the driving axis 13 of the carrying unit 3 and the driving axis 8a of the driving motor 8 are automatically connected only by fitting the carrying unit 3 from the upper side with tables 4a and 4b. And so, it is speedy and easy to assemble the circulation type conveying device.

Since, in such connecting mechanism, the driving motor 8 is previously provided in the base 2 as a driving means of carrying unit 3, the carrying unit 3 of present invention is lighter and easier to be set on the base 2 than a carrying unit 3 with driving motor 8 and so on.

As mentioned above, the embodiments of this present invention have been explained with using the drawings. The specific construction of present invention is not limited to these embodiments, and it will be obvious to those skilled in the art that various changes may be made without departing from the scope of the invention.

For example, as previous embodiment, the convex fitting part of carrying unit 3 is fitted between the opposite end faces of tables 4a and 4b, but the bottom half section of the carrying unit 3 also can be fitted directly without using any convex fitting part 9.

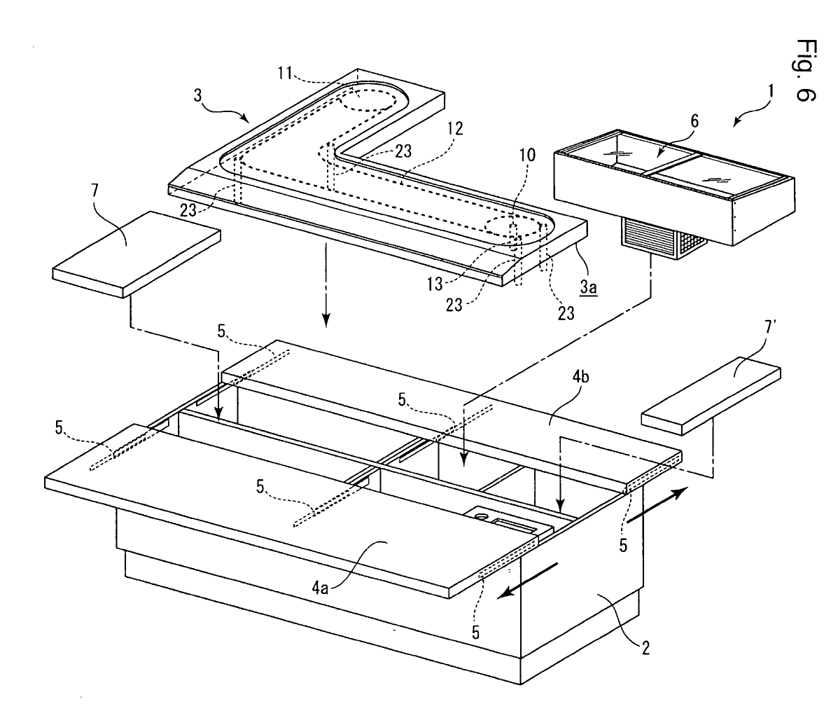

Moreover, without using any convex fitting parts 9 and the like on the underside of carrying unit 3 as shown in FIG. 6, the location of the installation of carrying unit 3 in relation to base 2 can be determined only with the previously mentioned positioning shaft 23. Further, in this case, if spacer plate 7′ will be arranged in the space formed between tables 4a and 4b in the side of base 2, the movement of the tables 4a and 4b can be surely prevented.

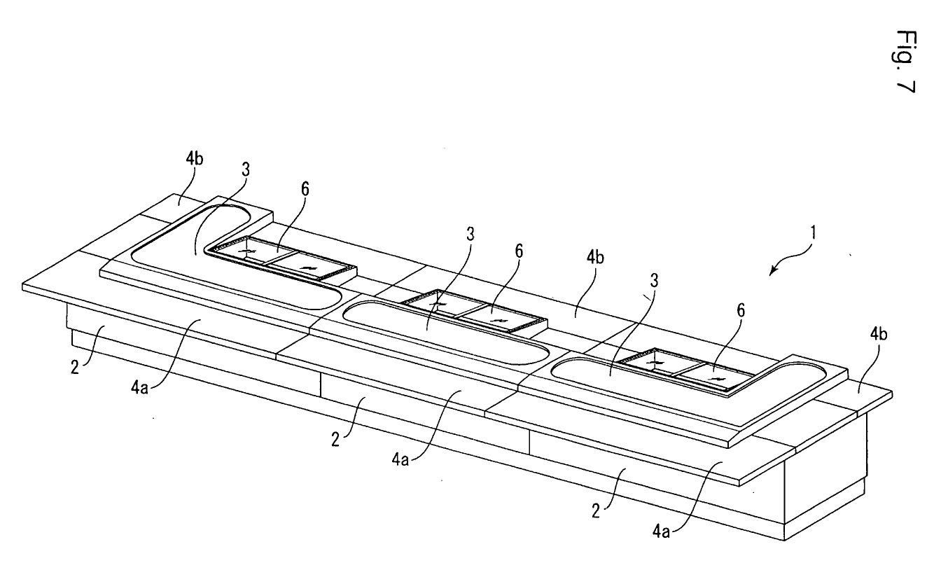

In above mentioned embodiment, the circulation type conveying device is composed of only single base 2, but as shown in FIG. 7, several bases 2 with carrying unit 3 may be assembled in a crosswise direction. By selecting connection number of bases 2, the length of carrying unit 3 can be made long or short freely.

Even more, although it is not shown in the related Figures, a longitudinally formed carrying unit 3 can be set on multiple bases 2.

Moreover, the configuration of carrying unit 3 is not limited to the shape of the letter L in the planar view. As the center of carrying unit 3 shown in FIG. 7, a straight line configuration can be selected as well.

Furthermore, as mentioned in the previous embodiment, the tables 4a and 4b of base 2 are made of a pair of tables to be able to open and close the upper part opening of the base 2 from both sides, but present invention is not limited to such embodiment. If the base 2 has at least opening part at the upper part of it and the table can move to open and close the opening part of base 2, the table may be made of one table.

Also, as mentioned in the previous embodiment, the tables 4a and 4b can slide freely between the closing position and the opening position by slide rail 5, but the movement mechanism of table is not limited to sliding mechanism. For example, tables may be opened and closed by hinges.

Also, as mentioned in the previous embodiment, the driving motor 8 as a driving means of carrying unit 3 is placed on the side of base 2, but it is also possible to place the driving motor 8 on the side of carrying unit 3.

Also, the transport mechanism for circulating the conveyed items in carrying unit 3, as mentioned in the previous example, is not only to use attractive force of magnet M, but also to use moving surface known conventionally as the crescents chain conveyor etc. to carry the conveyed items.

1. A circulation type conveying device comprising a base, a carrying unit placed on the upper part of the base and cyclically moving carried articles, and the tables,
wherein the base is opened at least on one part of its upper side,
the tables are movable between a position where the opening of the base is closed and a position where they are projected outwardly from the base to open the opening,
the carrying unit is able to be placed on the opening portion of the base, and
the tables and the carrying unit are immovably assembled into the base when the carrying unit is placed on the base.

2. The circulation type conveying device according to claim 1, wherein the movement of the tables is restricted by the rail put on the base, and the carrying unit's movement toward the tables is restricted by the tables which are in the position where the tables open the opening of the base and their movement is restricted.

3. The circulation type conveying device according to claim 1, wherein the storage box is mounted on the base and removed from it, the carrying unit's movement toward the storage box is restricted by the storage box which is set up within the base.

4. The circulation type conveying device according to claim 1, wherein the tables are consisted of a pair of tables which can open and close the opening from both sides.

5. The circulation type conveying device according to claim 4, wherein the carrying unit is fit in between the pair of tables which open the opening.

6. The circulation type conveying device according to claim 1, wherein the carrying unit has a connecting means by which the carrying unit is automatically connected with a driving means set in the base for driving the carrying unit when the carrying unit is placed on the base.

7. The circulation type conveying device according to claim 6, wherein the carrying unit has a locating pole in its under surface to decide its setting position on the base, and the locating pole is fitted into a locating hole set within the base before the connecting means is connected with the driving means in the carrying unit being placed on the base.

8. The circulation type conveying device according to claim 1, wherein several of the bases set with the carrying unit are connected continuously.
